(19) United States
(12) Patent Application Publication
(10) Pub. No.: US 2019/0114392 A1
(43) Pub. Date: Apr. 18, 2019

(54) METAGENOMIC NGS READ CLASSIFICATION AND INTRINSIC ACCURACY MEASURE THROUGH SEQUENCE FRAGMENTATION

(71) Applicant: INTERNATIONAL BUSINESS MACHINES CORPORATION, Armonk, NY (US)

(72) Inventors: Laxmi P. PARIDA, Mohegan Lake, NY (US); Filippo UTRO, Pleasantville, NY (US)

(21) Appl. No.: 15/785,889

(22) Filed: Oct. 17, 2017

(51) Int. Cl. G06F 19/22; G06F 19/28; G06F 19/18

(52) U.S. Cl. CPC G06F 19/22; G06F 19/18; G06F 19/28

(57) ABSTRACT

Embodiments include methods, systems, and computer program products for identifying a metagenomic read. Aspects include receiving a metagenomic read of a sample. Aspects also include comparing the metagenomic read to a genomic database including a plurality of gene sequences. Aspects also include randomly fragmenting the metagenomic read into two read fragments. Aspects also include comparing the read fragments to the genomic database including a plurality of gene sequences. Aspects also include generating an identification based at least in part on a determination that a read fragment exactly matches a gene sequence.

### BACKGROUND

The present invention relates to metagenomic analysis, and more specifically, to methods, systems and computer program products for metagenomic next generation sequencing (NGS) read classification with an intrinsic accuracy measure.

Metagenome classification involves extraction and identification of genomic sequences from environmental samples. Environmental samples, such as soil samples, food samples, or biological tissue samples can contain extremely large numbers of organisms and, consequently, generate a large set of genomic data. For example, it is estimated that the human body, which relies upon bacteria for modulation of digestive, endocrine, and immune functions, can contain up to 100 trillion organisms. In the past decade, advances in sequencing and screening technologies have increased the potential for determining the microbial composition of previously unknown samples. It is desirable to determine the microbial composition of an environmental sample as quickly and as accurately as possible.

### SUMMARY

In accordance with embodiments of the invention, a computer-implemented method for identifying a metagenomic read is provided. A non-limiting example of the method includes receiving, by a processor, a metagenomic read of a sample. The method also includes comparing, by the processor, the metagenomic read to a genomic database including a plurality of gene sequences. The method also includes randomly fragmenting, by the processor, the metagenomic read into two read fragments. The method also includes comparing, by the processor, the read fragments to the genomic database including a plurality of gene sequences. The method also includes generating, by the processor, an identification based at least in part upon a determination that a read fragment exactly matches a gene sequence.

In accordance with embodiments of the invention, a computer program product for identifying a metagenomic read is provided. The computer program product includes a computer readable storage medium readable by a processing circuit and storing program instructions for execution by the processing circuit for performing a method. A non-limiting example of the method includes receiving a metagenomic read of a sample. The method also includes comparing the metagenomic read to a genomic database including a plurality of gene sequences. The method also includes randomly fragmenting the metagenomic read into two read fragments. The method also includes comparing the read fragments to the genomic database including a plurality of gene sequences. The method also includes generating an identification based at least in part upon a determination that a read fragment exactly matches a gene sequence.

In accordance with embodiments of the invention, a processing system for identifying a metagenomic read includes a processor in communication with one or more types of memory. The processor is configured to receive a metagenomic read of a sample. The processor is also configured to compare the metagenomic read to a genomic database including a plurality of gene sequences. The processor is also configured to randomly fragment the metagenomic read into two read fragments. The processor is also configured to compare the read fragments to the genomic database including a plurality of gene sequences. The processor is also configured to generate an identification based at least in part upon a determination that a read fragment exactly matches a gene sequence.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The subject matter of the present invention is particularly pointed out and distinctly claimed in the claims at the conclusion of the specification. The foregoing and other features and advantages of the one or more embodiments described herein are apparent from the following detailed description taken in conjunction with the accompanying drawings in which:

FIG. 1 is block diagram illustrating one example of a processing system for practice of the teachings herein;

FIG. 2 is a flow diagram illustrating a method for identifying a metagenomic read according to one or more embodiments of the present invention.

FIG. 3 depicts a diagram illustrating an exemplary system for identifying a metagenomic read according to one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the described embodiments, the various elements illustrated in the figures are provided with two or three digit reference numbers. With minor exceptions, the leftmost digit(s) of each reference number correspond to the figure in which its element is first illustrated.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

Metagenomics, the study of genomic species obtained directly from the environment, is a desirable area of study that can be computationally and experimentally challenging. Current methods are subject to problems of sensitivity, specificity and interpretation.

Metagenome sequencing can be performed in three stages. First, an environmental sample can be prepared. For instance, DNA from a sample can be isolated and then fragmented to obtain sequence fragments small enough for current sequencing techniques. Thereafter, sample preparation can include blunting the fragment ends and ligating adaptors to the DNA fragments, for instance, to enable substrate attachment in sequencing applications. Second, the prepared samples can be sequenced. Sequencing generally includes High Throughput Sequencing methods. Third, the sequence data can be analyzed with bioinformatics to identify and further analyze the genomic content of a sample. The reads from metagenomics samples must be mapped to their respective gene, or a species, genus, or other taxonomic entity (OTU, Operational Taxonomic Unit).

Given a genomic database and associated taxonomy for a next generation sequencing (NGS) read, wherein it is not known a priori from what organism the NGS read originated, the task of identifying the organism or a position in the taxonomy of the database can be challenging. Conventional metagenome read identification can be cumbersome, computationally expensive, and time consuming. For example, even where a read is known to belong to a particular organism, simply applying the read to a known sequence of the organism may or may not necessarily result in a positive identification due to sequencing errors or mutations. Conventional approaches to overcome mismatches in metagenomic sequences can suffer from false positives or false negatives or can be time- or cost-prohibitive.

Metagenome sequencing can be performed in multiple stages. First, an environmental sample can be prepared. For instance, DNA from a sample such as a soil sample or a biological sample can be isolated and prepared for sequencing techniques. Sample preparation for DNA sequencing, for example, can include blunting the fragment ends and ligating adaptors to the DNA fragments, for instance, to enable substrate attachment in sequencing applications. Second, the prepared samples can be sequenced. Sequencing generally can include High Throughput Sequencing methods. After sequencing, a goal of metagenomic analysis is to identify and further analyze the genomic content of a sample. The reads from metagenomics samples must be mapped to their respective gene, or a species, genus, or other taxonomic entity (OTU, Operational Taxonomic Unit).

Sources of difficulty in mapping include, for example, problems with the comparative databases such as redundant candidates or inaccuracies due to errors in sequencing, errors in the databases, or differences due to genetic mutations and variants. Moreover, sequence errors can be introduced during the extraction process or in other biotechnological steps. As a result, in some cases, sequences can align with multiple OTUs in a database and in other cases, for example in the case of long fragments with errors or mutations, sequences can align with no OTUs in a database despite the presence of a matching OTU. In addition, many different environmental strains contain significant and extensive genetic overlap, posing challenges to proper identification.

A conventional technique that seeks to balance the need for reducing false positives while maintaining an ability to find a matching OTU applies metagenomic reads of a mixed minimum length to an indexed and/or annotated genomic sample and advances the reads along the indexed and/or annotated genomic sample by a nucleotide base of fixed length “k”. However, such methods are strongly dependent from the value of “k,” can require multiple iterations that are computationally expensive and time consuming, and thus, the usefulness of such identifications is limited to those applications in which time is in abundance, and can provide poor accuracy results.

Turning now to an overview of the aspects of the invention, one or more embodiments of the invention address the above-described shortcomings of the prior art by fragmenting metagenomic reads at random points and applying the random read fragments, sometimes referred to as seeds, to an indexed and/or annotated genomic database. This process can be iteratively repeated until an exact match is located or a minimal fragment length is achieved. Embodiments of the invention, for instance, can generate a read classification even where a mutation or sequencing error is present in the metagenomic read by randomly fragmenting the read and relying, at least in part, upon an exact match of the read fragment, or seed, that does not include the mutation or error with the relevant genomic sequence. As used herein, an exact match of a read fragment is understood to mean an exact match between the nucleotide sequence of the read fragment or a reverse compliment of the read fragment and the relevant genomic sequence or portion of the relevant genomic sequence.

The randomization in embodiments of the invention enables bootstrapping, such that measures of accuracy can be derived from multiple runs. Each read can have an intrinsic measure of robustness and can be used in any genomic database for rapid identification or classification. For example, through multiple applications of the fragmented reads to the genomic database, exact matches to an OTU can be statistically characterized by known statistical parameters, such as p-values or confidence levels. Accordingly, embodiments of the invention can include an intrinsic accuracy measure.

The above-described aspects of the invention address the shortcomings of the prior art by providing rapid classification and identification of a metagenomic sample. Such methods can improve human health and food and environmental safety, for example, by providing rapid identification of harmful pathogens. Moreover, embodiments of the invention provide precise and accurate identifications and classifications of metagenome samples. In some embodiments of the invention, statistical measures of accuracy of a resultant classification or identification can be provided.

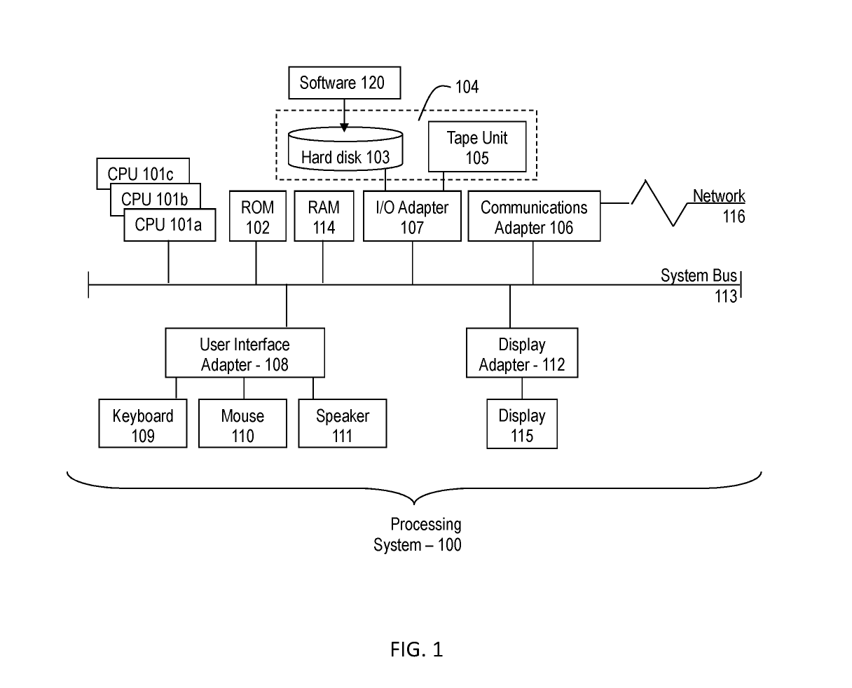

Turning now to a more detailed description of aspects of the present invention, FIG. 1 depicts an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 can include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Software 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system such as the AIX® operating system from IBM Corporation to coordinate the functions of the various components shown in FIG. 1.

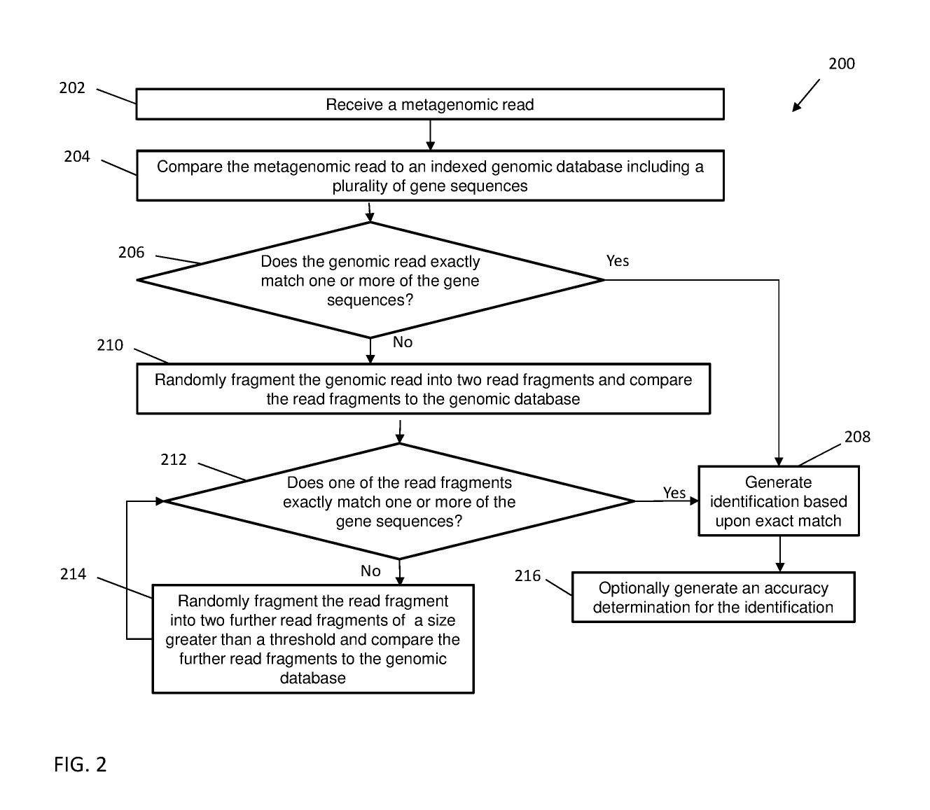

Referring now to FIG. 2, a method 200 for identifying a metagenomic read according to one or more embodiments of the present invention is provided. The method 200 includes, as shown at block 202, receiving a metagenomic read of a sample. The metagenomic read can be obtained by known methods including conventional high throughput sequencing of a sample. The method also includes, as shown at block 204, comparing the metagenomic read to an indexed and/or annotated genomic database including a plurality of gene sequences. The method also includes, as shown at decision block 206, determining whether the genomic read exactly matches a gene sequence. Responsive to a determination that the genomic read exactly matches a gene sequence, the method proceeds to block 208 and generates an identification based at least in part upon the exact match. Responsive to a determination that the genomic read does not exactly match a gene sequence, the method proceeds to block 210 and randomly fragments the genomic read into two read fragments and compares the read fragments to the genomic database.

Comparison of read fragments to a genomic database can include computationally comparing DNA sequences of the read fragments to known DNA sequence data in existing databases.

The method also includes, as shown at decision block 212 determining whether one of the read fragments exactly matches one or more of the gene sequences. Responsive to a determination that the read fragment exactly matches a gene sequence, the method proceeds to block 208 and generates an identification based at least in part upon the exact match. Responsive to a determination that the read fragment does not exactly match a gene sequence, the method can proceed to block 214 and randomly fragments the read fragments into two further read fragments and compares the further read fragments to the genomic database. In some embodiments, the method can then return to block 212.

Embodiments of the invention include performing multiple iterations of read fragmentation and application to indexed or annotated gene sequences. The number of iterations can be selected by those skilled in the art based upon, for example, the sample type, the number of resultant reads at each run, the resultant accuracy measures after each run, a designated processing time, and/or the desired accuracy or sensitivity of the read classification. For example, a process can be repeated until an exact match is identified. In some embodiments of the invention, a process can be repeated until a minimal fragment length is reached.

In some embodiments of the invention, an output is generated. The output can include an identification of an organism associated with a read. In some embodiments of the invention, an output includes a position in the taxonomy. In some embodiments of the invention, an output includes a plurality of identifications for one or more reads. In some embodiments of the invention, an output includes one or more identifications and associated accuracy measures for the identifications.

The method also includes, as shown at block 216, optionally generating an accuracy determination for the identification. The accuracy determination can include a statistical parameter, such as a p-value or a confidence, reflecting the accuracy for the identification. The accuracy determination can be derived from multiple runs, wherein each run includes a comparison of a set of reads or a set of read fragments with the genomic database.

In some embodiments of the invention, the metagenomic read classifications can be filtered based at least in part upon the accuracy determination. For example, metagenomic reads having a relatively low confidence level, such as a confidence of less than 50% or 90% or 99%, can be discarded.

In some embodiments of the invention, the read fragments are each larger than a fixed minimal length. The fixed minimal length can be defined by a user and can be set, for example, based upon the sample type, the genomic database, the read sizes, the desired analysis time or accuracy. In some embodiments of the invention, the fixed minimal length is 15 or 16 bases. A person skilled in the art can select the fixed minimal length based upon, for instance, the type of sample, the quality and number of matching reads in a run, or the desired accuracy or precision.

In some embodiments of the invention, the sample is a biological fluid sample, a biological tissue sample, a food sample, or a soil sample. For example, a sample can include a food sample for the identification of pathogens, such as salmonella. In some embodiments of the invention, a sample can include human saliva or plasma for the identification of viruses.

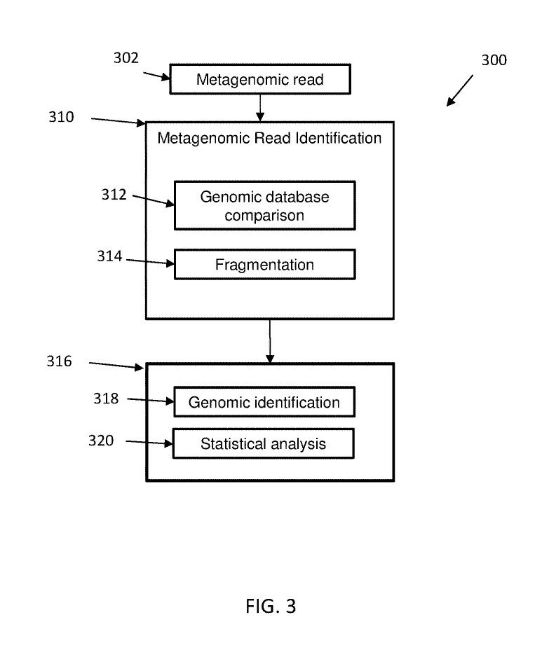

FIG. 3 illustrates an exemplary system 300 for identifying a metagenomic read according to one or more embodiments of the present invention. The system 300 can include an input 302 containing one or more metagenomic reads of a sample. The system 300 can also include a metagenomic read identification engine 310, which can include a genomic database comparison hub 312 and a read fragmentation hub 314. The system 300 can also include an output display 316 including, for instance, a genomic identification 318 and a statistical analysis result 320 for the genomic identification.

In accordance with embodiments of the invention, any genomic database including known characterizations of gene sequences can be used. In some embodiments of the invention, a plurality of genomic databases are used. Genomic databases that can be used in embodiments of the invention are known, and include, for instance, existing databases such as Silva, Greengenes, NCBI, Ensembl reference genome databases and the like.

For example, embodiments of the invention can receive a metagenomic read for a sample, such as a soil sample, and seek to identify organisms within the sample quickly and accurately. The DNA sequences within the metagenomic reads can be applied to one or more genomic databases. If a read exactly matches an indexed and/or annotated sequence in the database, no further analysis is required and an identification can be generated and output to a display. If no exact match is generated, the reads can be randomly fragmented into two pieces of a size larger than a fixed length, such as 16.

The fragmentation and application can be repeated. For example, the fragmentation and application can be repeated until an exact match is determined or until fragments reach the fixed length. The randomized process can enable bootstrapping. For example, accuracy can be derived from multiple runs.

Embodiments of the invention can provide rapid identification of undesirable agents, such as viruses or bacteria, for human health and safety issues. For instance, in a hospital setting, visitor saliva can be tested for the presence of undesirable agents prior to entry into areas having immune compromised patients. The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form described. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There can be many variations to this diagram or the steps (or operations) described therein without departing from the spirit of embodiments of the invention. For instance, the steps can be performed in a differing order or steps can be added, deleted or modified. All of these variations are considered a part of the claimed invention.

The descriptions of the various embodiments of the present invention have been presented for purposes of illustration, but are not intended to be exhaustive or limited to the embodiments described. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for identifying a metagenomic read, the method comprising:
receiving, by a processor, a metagenomic read of a sample;
comparing, by the processor, the metagenomic read to a genomic database comprising a plurality of gene sequences;
randomly fragmenting, by the processor, the metagenomic read into two read fragments;
comparing, by the processor, the read fragments to the genomic database comprising the plurality of gene sequences; and
generating, by the processor, an identification based at least in part on a determination that a read fragment exactly matches one or more of the plurality of gene sequences.

2. The computer-implemented method of claim 1, wherein the read fragments are each larger than a fixed minimal length.

3. The computer-implemented method of claim 2, wherein the fixed minimal length is 15 bases.

4. The computer-implemented method of claim 1, wherein the method further comprises generating an accuracy determination for the identification.

5. The computer-implemented method of claim 4, wherein the accuracy determination is based at least in part upon a plurality of runs, wherein each run comprises a comparison of a set of reads or a set of read fragments with the genomic database.

6. The computer-implemented method of claim 1 further comprising randomly fragmenting each of the read fragments into two further read fragments and comparing the further read fragments to the genomic database.

7. The computer-implemented method of claim 1, wherein the genomic database comprises an indexed genomic database or an annotated genomic database.

8. The computer-implemented method of claim 1, wherein the sample is a biological fluid sample, a biological tissue sample, a food sample, or a soil sample.

9. A computer program product for identifying a metagenomic read, the computer program product comprising:
a computer readable storage medium readable by a processing circuit and storing program instructions for execution by the processing circuit for performing a method comprising:
receiving a metagenomic read of a sample;
comparing the metagenomic read to a genomic database comprising a plurality of gene sequences;
randomly fragmenting the metagenomic read into two read fragments;
comparing the read fragments to the genomic database comprising the plurality of gene sequences;
generating an identification based at least in part upon a determination that a read fragment exactly matches one or more of the plurality of gene sequences.

10. The computer program product of claim 9, wherein the read fragments are each larger than a fixed minimal length.

11. The computer program product of claim 10, wherein the fixed minimal length is 15 bases.

12. The computer program product of claim 9, wherein the method further comprises generating an accuracy determination for the identification.

13. The computer program product of claim 12, wherein the accuracy determination is based at least in part upon a plurality of runs, wherein each run comprises a comparison of a set of reads or a set of read fragments with the genomic database

14. The computer program product of claim 9, wherein the method further comprises randomly fragmenting each of the read fragments into two further read fragments and comparing the further read fragments to the genomic database.

15. The computer program product of claim 9, wherein the sample is a biological fluid sample, a biological tissue sample, a food sample, or a soil sample.

16. A processing system for identifying a metagenomic read, the system comprising:
a processor in communication with one or more types of memory, the processor configured to:
receive a metagenomic read of a sample;
compare the metagenomic read to a genomic database comprising a plurality of gene sequences;
randomly fragment the metagenomic read into two read fragments;
compare the read fragments to the genomic database comprising the plurality of gene sequences;
generate an identification based at least in part upon a determination that a read fragment exactly matches one or more of the plurality of gene sequences.

17. The processing system of claim 16, wherein the read fragments are each larger than a fixed minimal length.

18. The processing system of claim 17, wherein the fixed minimal length is 15 bases.

19. The processing system of claim 16, wherein the method further comprises generating an accuracy determination for the identification

20. The processing system of claim 16, wherein the method further comprises randomly fragmenting each of the read fragments into two further read fragments and comparing the further read fragments to the genomic database.
